(19) United States
(12) Patent Application Publication
(10) Pub. No.: US 2026/0168062 A1
(43) Pub. Date: Jun. 18, 2026

(54) HOT-ROLLED NON-ORIENTED ELECTRICAL STEEL SHEET AND METHOD FOR MANUFACTURING SAME

(71) Applicant: POSCO CO., LTD, Gyeongsangbuk-do, Pohang-si (KR)

(72) Inventors: Soobin Kwon, Pohang-si, Gyeongsangbuk-do (KR); Yun Su Kim, Pohang-si, Gyeongsangbuk-do (KR)

(73) Assignee: POSCO CO., LTD, Gyeongsangbuk-do, Pohang-si (KR)

(21) Appl. No.: 19/129,554

(22) PCT Filed: Sep. 21, 2023
(86) PCT No.: PCT/KR2023/014380

§ 371 Date: May 13, 2025

(30) Foreign Application Priority Data
Dec. 8, 2022 (KR) 10-2022-0170292

(51) Int. Cl. C22C 38/00; C22C 38/04

(52) U.S. Cl. CPC C22C 38/001; C22C 38/04

(57) ABSTRACT

A hot rolled non-oriented electrical steel sheet according to an embodiment includes: 2.8 to 4.0% of Si, 0.1 to 1.3% of Al, 0.3 to 2.0% of Mn as wt %, a balance of Fe, and inevitable impurities, and satisfies Equation 1:

$$1.1 \leq Hv 1 / HV 2 \leq 1.5 \qquad [ Equation 1 ]$$

(here, Hv1 is hardness measured on a surface of the steel sheet, and Hv2 is hardness measured at a ½ point of thickness of the steel sheet.)

### TECHNICAL FIELD

The present disclosure relates to a hot rolled non-oriented electrical steel sheet and a manufacturing method thereof. The present disclosure relates to a hot rolled non-oriented electrical steel sheet for removing scales by projecting shot balls to a steel sheet during a manufacturing process, adjusting hardness of surfaces and insides, and thereby improving iron loss after iron loss and stress removal annealing in entire directions, and a manufacturing method thereof.

### BACKGROUND ART

Non-oriented electrical steel sheets are mainly used in motors that convert electrical energy into mechanical energy, and in order to achieve high efficiency in the process, excellent magnetic characteristics of the non-oriented electrical steel sheets are required. In particular, as environmentally-friendly technologies have been gaining attention recently, increasing the efficiency of motors, which occupy more than half of the total electrical energy usage, is considered very important, and for this purpose, the demand for non-oriented electrical steel sheets with excellent magnetic characteristics is also increasing. The magnetic characteristics of non-oriented electrical steel sheets are mainly evaluated by iron loss and flux density. The iron loss refers to the energy loss that occurs at a specific flux density and frequency, and the flux density refers to the degree of magnetization obtained in a specific magnetic field. The lower the iron loss is, the more energy-efficient the motor may be manufactured under the same conditions, and the higher the flux density is, the smaller the motor may be or copper loss may be reduced, and hence, it is important to manufacture a non-oriented electrical steel sheet with low iron loss and high flux density.

The characteristics of the non-oriented electrical steel sheets that must be considered also change depending on the operating conditions of the motor. As a reference for evaluating the characteristics of the non-oriented electrical steel sheets used in the motors, the iron loss of W15/50 when the motors are subjected to a 1.5 T magnetic field at a commercial frequency of 50 Hz is considered most important. However, not all the motors for various purposes consider the iron loss of W15/50 as the most important, and the iron loss at different frequencies or magnetic fields may be evaluated depending on the main operating conditions. Especially in the case of non-oriented electrical steel sheets used in recent electric vehicle driving motors, magnetic characteristics are often important at low magnetic fields of 1.0 T or less and high frequencies of 400 Hz or more, so the characteristics of non-oriented electrical steel sheets are evaluated by the iron loss such as W10/400.

Also, a motor core may be divided into a stator core and a rotor core. Recently, in order to satisfy the demand for small size and high power for HEV driving motors, etc., the non-oriented electrical steel sheet used for the stator core is strongly required to have excellent magnetic characteristics such as high magnetic flux density and low iron loss.

In addition, as a means of achieving small size and high power in the HEV driving motors, there is a tendency for the number of revolutions of the motor to increase, but since the exterior diameter of the HEV driving motor is large, a large centrifugal force is applied to the rotor core, and also, depending on the structure, there is a very narrow part called the rotor core bridge part, so the non-oriented electrical steel sheet used in the rotor core is required to have higher strength than before.

Therefore, the characteristics of the non-oriented electrical steel sheets used for motor cores are ideal for excellent magnetic characteristics, high strength for rotor cores, and higher flux density and low iron loss for stator cores. The non-oriented electrical steel sheet used for the same motor core has significantly different characteristics required for the rotor core and the stator core, but regarding manufacturing the motor core, from the viewpoint of increasing the material yield, etc., it is preferable to simultaneously produce the rotor core material and the stator core material from the same material steel sheet, and then laminate each core material to assemble it into a rotor core or stator core.

### DISCLOSURE

### Technical Problem

The present disclosure attempts to provide a hot rolled non-oriented electrical steel sheet and a manufacturing method thereof. The present disclosure attempts to provide a hot rolled non-oriented electrical steel sheet for removing scales by projecting shot balls to a steel sheet during a manufacturing process, adjusting hardness of surfaces and insides, and thereby improving iron loss after iron loss and stress removal annealing in entire directions, and a manufacturing method thereof.

### Technical Solution

An embodiment of the present disclosure provides a hot rolled non-oriented electrical steel sheet including: 2.8 to 4.0% of Si, 0.1 to 1.3% of Al, 0.3 to 2.0% of Mn as wt %, a balance of Fe, and inevitable impurities, and satisfying Equation 1:

$$1.1 \leq Hv 1 / HV 2 \leq 1.5 \qquad [ Equation 1 ]$$

(here, HV1 is hardness measured on a surface of the steel sheet, and HV2 is hardness measured at a ½ point of thickness of the steel sheet.)

The hot rolled non-oriented electrical steel sheet may further include at least one of 0.2 wt % or less of Cr (excluding 0%), 0.06 wt % or less of Sn (excluding 0%), and 0.06 wt % or less of Sb (excluding 0%).

The hot rolled non-oriented electrical steel sheet may further include at least one of 0.01 to 0.2 wt % of Cu, 0.100 wt % or less of P (excluding 0%), 0.05 wt % or less of Ni (excluding 0%), and 0.01 wt % or less of Zn (excluding 0%).

The hot rolled non-oriented electrical steel sheet may further include 0.005 wt % or less of one or more of C, N, S, Ti, Nb, and V individually or as a summed content thereof (excluding 0%).

The hot rolled non-oriented electrical steel sheet may further include 0.200 wt % or less of one or more of Bi, Pb, Ge and As individually or as a summed content thereof (excluding 0%).

The hot rolled non-oriented electrical steel sheet may further include at least one of 0.03 wt % or less of Mo (excluding 0%), 0.0050 wt % or less of B (excluding 0%), 0.0050 wt % or less of Ca (excluding 0%), and 0.0050 wt % or less of Mg (excluding 0%).

Another embodiment of the present disclosure provides a non-oriented electrical steel sheet including: 2.8 to 4.0% of Si, 0.1 to 1.3% of Al, 0.3 to 2.0% of Mn as wt %, a balance of Fe, and inevitable impurities, and satisfying Equation 2 and Equation 3:

$$2 \vert WL - WC \vert / ( WL + WC ) \leq 0.1 \qquad [ Equation 2 ]$$

$$2 \vert WL + WC - 2 WN \vert / ( WL + WC ) \leq 0.1 \qquad [ Equation 3 ]$$

(in Equation 2 and Equation 3, WL is iron loss (W10/1000, W/kg) measured in a rolling direction, WC is iron loss (W10/1000, W/kg) measured in a vertical direction to the rolling direction, and WN is iron loss (W10/1000, W/kg) measured in the direction forming the angle of 45 degrees with respect to the rolling direction. W10/1000 is iron loss (W/kg) when flux density of 1.0 T is induced at a frequency of 1000 Hz.)

The non-oriented electrical steel sheet may further include at least one of 0.2 wt % or less of Cr, 0.06 wt % or less of Sn, and 0.06 wt % or less of Sb.

An average grain particle diameter may be 5 to 50 μm.

Equation 4 may be satisfied after stress removal annealing:

$$W 10 / 1000 \leq 20 + t \times 150 \qquad [ Equation 4 ]$$

(here, W10/1000 is iron loss (W/kg) when the flux density of 1.0 T is induced at the frequency of 1000 Hz, and t is thickness (mm) of the steel sheet)

Another embodiment of the present disclosure provides a method for manufacturing a hot rolled non-oriented electrical steel sheet including: manufacturing a hot rolled plate by hot rolling a slab including 2.8 to 4.0% of Si, 0.1 to 1.3% of Al, 0.3 to 2.0% of Mn as wt %, a balance of Fe, and inevitable impurities; and removing a scale existing on a surface of the hot rolled plate, wherein the removing of a scale includes removing a scale by projecting a shot ball on to a steel sheet, and Equation 1 is satisfied after projecting a shot ball:

$$1.1 \leq Hv 1 / HV 2 \leq 1.5 \qquad [ Equation 1 ]$$

(here, HV1 is hardness measured on the surface of steel sheet, and HV2 is hardness measured at the ½ of the thickness of the steel sheet.)

A projecting amount of the shot balls may be 15 to 35 kg/(min·m²).

An average particle size of the shot ball may be 0.1 to 1 mm, and may be projected for 1 second to 60 seconds.

The shot ball may be made of a Fe-based alloy.

The method may further include annealing a hot rolled plate before the removing of a scale.

Another embodiment of the present disclosure provides a method for manufacturing a non-oriented electrical steel sheet including: manufacturing a hot rolled plate by hot rolling a slab including 2.8 to 4.0% of Si, 0.1 to 1.3% of Al, 0.3 to 2.0% of Mn as wt %, a balance of Fe, and inevitable impurities; removing a scale existing on a surface of the hot rolled plate; manufacturing a cold-rolled steel sheet by cold rolling the scale-removed hot rolled plate; and annealing the cold-rolled steel sheet, wherein the removing of a scale includes removing a scale by projecting a shot ball onto a steel sheet.

Equation 1 is satisfied after projecting a shot ball.

$$1.1 \leq Hv 1 / HV 2 \leq 1.5 \qquad [ Equation 1 ]$$

(here, HV1 is hardness measured on the surface of steel sheet, and HV2 is hardness measured at the ½ point of the thickness of the steel sheet.)

The slab may further include at least one of 0.2 wt % or less of Cr, 0.06 wt % or less of Sn, and 0.06 wt % or less of Sb.

A projecting amount of the shot balls may be 15 to 35 kg/(min·m²).

An average particle size of the shot ball may be 0.1 to 1 mm, and may be projected for 1 second to 60 seconds.

The shot ball may be made of a Fe-based alloy.

The annealing of a cold-rolled steel sheet includes performing annealing at the temperature of 700 to 850° C.

The method may further include annealing a hot rolled plate before the removing of a scale.

The steel sheet may satisfy Equation 2 and Equation 3 after the annealing of a cold-rolled steel sheet.

$$2 \vert WL - WC \vert / ( WL + WC ) \leq 0.1 \qquad [ Equation 2 ]$$

$$2 \vert WL + WC - 2 WN \vert / ( WL + WC ) \leq 0.1 \qquad [ Equation 3 ]$$

(in Equation 2 and Equation 3, WL is iron loss (W10/1000, W/kg) measured in the rolling direction, WC is iron loss (W10/1000, W/kg) measured in a vertical direction to the rolling direction, and WN is iron loss (W10/1000, W/kg) measured in the direction forming the angle of 45 degrees with respect to the rolling direction. W10/1000 is iron loss (W/kg) when the flux density of 1.0 T is induced at the frequency of 1,000 Hz.)

An average grain particle diameter may be 5 to 50 μm after the annealing of a cold-rolled steel sheet.

The method may further include performing stress removal annealing at the temperature of 700 to 850° C. for 10 to 300 minutes after the annealing of a cold-rolled steel sheet.

The steel sheet after the stress removal annealing may satisfy Equation 4.

$$W 10 / 1000 \leq 20 + t \times 150 \qquad [ Equation 4 ]$$

(here, W10/1000 is iron loss (W/kg) when the flux density of 1.0 T is induced at the frequency of 1,000 Hz, and t represents the thickness (mm) of the steel sheet.)

### Advantageous Effects

The non-oriented electrical steel sheet according to an embodiment may reduce accumulated energy on the surface when removing the scale. By this, influences may be applied to recrystallization during annealing a cold-rolled steel sheet, and deviation of the high-frequency iron loss in the directions of 0, 45, and 90 degrees of angle with respect to the rolling direction may be reduced.

The non-oriented electrical steel sheet according to the embodiment may contribute to the manufacturing of environmentally-friendly vehicle motors, high-efficiency home appliance motors, and super-premium motor cores.

### MODE FOR INVENTION

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Thus, a first element, component, region, layer, or section discussed below could be termed a second element, component, region, layer, or section without departing from the teachings of the present disclosure.

The technical terms used herein are to simply mention a particular embodiment and are not meant to limit the present disclosure. An expression used in the singular encompasses an expression of the plural, unless it has a clearly different meaning in the context. In the specification, it is to be understood that terms such as “including”, “having”, etc., are intended to indicate the existence of specific features, regions, numbers, stages, operations, elements, components, or combinations thereof disclosed in the specification, and are not intended to preclude the possibility that one or more other specific features, regions, numbers, operations, elements, components, or combinations thereof may exist or may be added.

When a part is referred to as being “on” another part, it can be directly on the other part or intervening parts may also be present. In contrast, when an element is referred to as being “directly on” another element, there are no intervening elements therebetween.

Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted to have the same meanings as contextual meanings in the relevant field of art, and are not to be interpreted to have idealized or excessively formal meanings unless clearly defined in the present application.

Unless otherwise specified, % represents wt %, and 1 ppm is 0.0001 wt %.

In an embodiment of the present disclosure, further including an additional element signifies that the added element is substituted for iron (Fe) that is a balance.

Embodiments of the present disclosure will now be described in detail so that those skilled in the art to which the present disclosure pertains may easily implement the embodiments. As those skilled in the art would realize, the described embodiments may be modified in various different ways, all without departing from the spirit or scope of the present disclosure.

The hot rolled non-oriented electrical steel sheet may include 2.8 to 4.0% of Si, 0.1 to 1.3% of Al, 0.3 to 2.0% of Mn, a balance Fe, and inevitable impurities as wt %, and may satisfy Equation 1.

$$1.1 \leq Hv 1 / HV 2 \leq 1.5 \qquad [ Equation 1 ]$$

(here, HV1 is hardness measured on a surface of steel sheet, and HV2 is hardness measured at the ½ point of thickness of the steel sheet.)

Limits of alloy components are as follows.

2.8 to 4.0 wt % of Si

Silicon (Si) serves to increase resistivity of a material to reduce iron loss, and when it is added very little, an effect of improving high-frequency iron loss may be insufficient. When very much of it is added, hardness of the material may increase to worsen a cold rolling property and deteriorate productivity and a punching property. Hence, Si may be added within the above-noted range. In detail, 3.0 to 3.8 wt % may be included. In further detail, 3.1 to 3.7 wt % may be included.

0.10 to 1.30 wt % of Al

Aluminum (Al) serves to increase resistivity of a material to reduce iron loss. When very little of it is added, there may be no high-frequency iron loss reduced effect, and nitride may be minutely formed to degrade magnetism. When very much of it is added, it may generate problems in the processes such as steelmaking and continuous casting, substantially deteriorating productivity. Hence, Al may be added within the above-noted range. In detail, 0.50 to 1.10 wt % may be included. In further detail, 0.70 to 1.00 wt % may be included.

0.3 to 2.0 wt % of Mn

Manganese (Mn) servers to increase resistivity of a material, improve iron loss, and form sulfide. When very little Mn is added, sulfide may be minutely precipitated to degrade magnetism. When very much Mn is added, formation of texture of {111} that is disadvantageous to magnetism may be promoted to reduce the flux density, and hence, Mn may be added within the above-noted range. In detail, 0.5 to 1.5 wt % of Mn may be included. In further detail, 0.7 to 1.3 wt % may be included.

In an embodiment, resistivity may be 55 to 80 ρΩ·cm.

The hot rolled non-oriented electrical steel sheet may further include at least one of 0.2 wt % or less of Cr (excluding 0%), 0.06 wt % or less of Sn (excluding 0%), and 0.06 wt % or less of Sb (excluding 0%).

0.20 wt % or less of Cr

Chromium (Cr) serves to increase resistivity of a material to reduce iron loss. Hence, Cr may be added in the above-noted range. In detail, 0.010 to 0.20 wt % may be included. In detail, 0.050 to 0.100 wt % may be included. As described, when additional elements are further included, they are included to replace the balance, Fe.

At least one of 0.06 wt % or less of Sn and 0.06 wt % or less of Sb

Tin (Sn) and antimony (Sb) are added to a crystal grain boundary as segregation elements for suppressing diffusion of nitrogen through the crystal grain boundary, suppressing {111} texture which is unfavorable to magnetism, and increasing favorable {100} texture to improve magnetic properties. When very much Sn and Sb are added, respectively, grain growth is hindered to deteriorate magnetism and rolling properties. Therefore, Sn and Sb may be added in the range described above. In detail, 0.005 to 0.060 wt % of Sn and 0.005 to 0.060 wt % of Sb may be included. In detail, 0.01 to 0.05 wt % of Sn and 0.01 to 0.05 wt % of Sb may be included.

The hot rolled non-oriented electrical steel sheet may further include at least one of 0.01 to 0.2 wt % of Cu, 0.100 wt % or less of P (excluding 0%), 0.05 wt % or less of Ni (excluding 0%), and 0.01 wt % or less of Zn (excluding 0%).

0.01 to 0.20 wt % of Cu

Copper (Cu) serves to form sulfide with Mn. When Cu is further added, if it is added too little, CuMnS may be finely precipitated to deteriorate magnetism. When very much Cu is added, high temperature brittleness may occur to form cracks during soft casting or hot rolling. In detail, 0.05 to 0.10 wt % of Cu may be included.

0.100 wt % or less of P

Since phosphorus (P) serves to increase the resistivity of a material and also is segregated in a grain boundary to improve texture to increase the resistivity and lower iron loss, it may be further added. When the amount of P added is very much, formation of texture which is unfavorable to magnetism is caused so that there is no effect of texture improvement, and P is excessively segregated in the grain boundary to deteriorate rollability and workability, which makes production difficult. Therefore, P may be added in the range described above. In detail, 0.001 to 0.090 wt % of P may be included. In detail, 0.005 to

0.085 wt % of P may be included.

0.05 wt % or less of Ni (excluding 0%) Nickel (Ni) may react to impurity elements to form fine sulfide, carbide, and nitride and may give a bad influence to magnetism. In detail, 0.001 to 0.03 wt % of Ni may be included.

0.01 wt % or less of Zn

When a content of zinc (Zn) is excessive, it may serve as an impurity to deteriorate magnetism. Hence, Zn may be further added in the above-described range. In detail, 0.001 to 0.005 wt % of Zn may be included.

The hot rolled non-oriented electrical steel sheet may further include 0.005 wt % or less of one or more of C, N, S, Ti, Nb, and V individually or as a summed content thereof.

0.005 wt % or less of C

When much carbon (C) is added, it expands an austenite region to increase a phase transformation section, suppresses crystal grain growth of ferrite during annealing to increase iron loss, is bonded to Ti and the like to form a carbide to deteriorate magnetism, and when processed into an electrical product as a final product and then used, it increases iron loss by magnetic aging. Therefore, C may be added in the range described above. In detail, 0.003 wt % or less of C may be included. In detail, 0.0001 to 0.003 wt % of C may be included.

0.005 wt % or less of S

Sulfur(S) forms a fine sulfide inside a base material to suppress crystal grain growth, thereby weakening iron loss, so it is preferable to add sulfur as little as possible. When S is included in a large amount, it is bonded to Mn and the like to form a precipitate or cause high temperature brittleness during hot rolling. Hence, 0.005 wt % or less of S may be further included. In detail, 0.0030 wt % or less of S may be further included. In further detail, 0.0001 to 0.0030 wt % of S may be further included.

0.005 wt % or less of N

Nitrogen (N) is strongly bonded to Al, Ti, and the like to form a nitride and suppress crystal grain growth, and since it hinders movement of a magnetic domain when precipitated, it is preferred to contain less N. Therefore, N may be added in the above-noted range. In detail, 0.003 wt % or less of N may be included. In detail, 0.0001 to 0.003 wt % of N may be included.

0.005 wt % or less of Ti, Nb, and V

Since titanium (Ti), niobium (Nb), vanadium (V) and the like are also strong carbide forming elements, it is preferred not to add them if possible, and they are included at 0.01 wt % or less, respectively. In detail, 0.0001 to 0.003 wt % of each of them may be included.

The hot rolled non-oriented electrical steel sheet may further include 0.200 wt % or less of one or more of Bi, Pb, Ge, and As 1 individually or as a summed content thereof (excluding 0%).

When the above-noted elements are added, they may be segregated at the grain boundary, thereby relieving the concentration of stress at the grain boundary during cold rolling, and suppressing the recrystallization of orientation grains of <111>//ND in the post-process that is recrystallization annealing, thereby improving the flux density. When these are added appropriately, the aforementioned effects may be additionally obtained, but when they are included very much, a large amount of segregation may occur, suppressing the grain growth and deteriorating the flux density and iron loss. In detail, 0.0001 to 0.200 wt % of one or more of Bi, Pb, Ge and As 1 may be further included individually or a summed content thereof. In detail, 0.001 to 0.100 wt % thereof may be further included. In detail, 0.005 to 0.050 wt % thereof may be further included.

The hot rolled non-oriented electrical steel sheet may further include at least one of 0.03 wt % or less of Mo (excluding 0%), 0.0050 wt % or less of B (excluding 0%), 0.0050 wt % or less of Ca (excluding 0%), and 0.0050 wt % or less of Mg (excluding 0%).

They may react with the inevitably included C, S, N, etc. to form fine carbide, nitride, or sulfide, which may adversely affect magnetism, so the upper limit may be restricted as described above.

The balance includes Fe and inevitable impurities. The inevitable impurities are mixed in during the steelmaking process and the process for manufacturing non-oriented electrical steel sheets, which is widely known in the field, and a detailed description thereof will be omitted. In addition to the alloy component described above in an embodiment, the addition of elements is not excluded, and the elements may be included in various ways within a range that does not harm the technical idea of the present disclosure. When additional elements are further included, they are included to replace the balance, Fe.

The hot rolled non-oriented electrical steel sheet satisfies Equation 1 when surface hardness is set to be HV1, and ½t the hardness in a depth direction is set to be HV2.

$$1.1 \leq Hv 1 / HV 2 \leq 1.5 \qquad [ Equation 1 ]$$

(here, HV1 is hardness measured on the surface of steel sheet, and HV2 is hardness measured at the ½ point of the thickness of the steel sheet.) Accumulated energy on the surface may be accordingly reduced by adjusting hardness ratios on the surface and the inside. By this, influences may be applied to recrystallization during annealing a cold-rolled steel sheet, and deviation of the high-frequency iron loss in the directions of 0, 45, and 90 degrees of angle with respect to the rolling direction may be reduced. In detail, the ratio of Hv1/Hv2 may be 1.2 to 1.4.

The hardness is Vickers hardness, and may be measured at a load of 10 g using a micro Vickers hardness tester. Hv1 may be 250 to 400 Hv, and Hv2 may be 150 to 300 Hv.

The hot rolled non-oriented electrical steel sheet may be used as a material of the motor core or may be used as a hot rolled material for additionally performing a cold rolling process and a cold-rolled steel sheet annealing process.

The non-oriented electrical steel sheet includes, as wt %, 2.8 to 4.0% of Si, 0.1 to 1.3% of Al, 0.3 to 2.0% of Mn, a balance Fe, and inevitable impurities.

The reason for limiting the addition ratio of each composition in the non-oriented electrical steel sheet is the same as the reason for limiting the composition of the hot rolled non-oriented electrical steel sheet described above, so a repeated description will be omitted. Since the steel composition does not change substantially in the manufacturing processes such as additional cold rolling and cold-rolled steel sheet annealing, the composition of the hot rolled non-oriented electrical steel sheet and the composition of the non-oriented electrical steel sheet are substantially the same.

The steel sheet may satisfy Equation 2 and Equation 3.

$$2 \vert WL - WC \vert / ( WL + WC ) \leq 0.1 \qquad [ Equation 2 ]$$

$$2 \vert WL + WC - 2 WN \vert / ( WL + WC ) \leq 0.1 \qquad [ Equation 3 ]$$

(in Equation 2 and Equation 3, WL is iron loss (W10/1000, W/kg) measured in the rolling direction, WC is iron loss (W10/1000, W/kg) measured in a vertical direction to the rolling direction, and WN is iron loss (W10/1000, W/kg) measured in the direction forming the angle of 45 degrees with respect to the rolling direction. W10/1000 is iron loss (W/kg) when the flux density of 1.0 T is induced at the frequency of 1,000 Hz.)

Equation 2 and Equation 3 may formulate the deviation of high-frequency iron loss in the directions of 0, 45, and 90 degrees of angle. The smaller the values of Equation 2 and Equation 3, the smaller the deviation of iron loss. When manufacturing a motor using the non-oriented electrical steel sheet satisfying these, the efficiency of the motor may be maximized. In detail, values of Equation 2 and Equation 3 may be 0.09 or less. Lower limits of Equation 2 and Equation 3 are not specifically restricted and are 0.

An average diameter of grain particles of the non-oriented electrical steel sheet may be 5 to 50 μm. When the grains are very small, iron loss may be degraded. When the grains are very big, mechanical strength may be deteriorated. In detail, it may be 10 to 40 μm. The grain particle diameter may be measured by assuming a circle with the same area as the grain and measuring the particle diameter of that circle. The reference surface may be measured on a plane parallel to the rolling surface (ND surface) and may be measured at ¼ to ¾ of the thickness of the steel sheet. The average represents a numerical average.

The non-oriented electrical steel sheet may satisfy Equation 4 after stress removal annealing at the temperature of 700 to 850° C. for 10 to 300 minutes.

$$W 10 / 1000 \leq 20 + t \times 150 \qquad [ Equation 4 ]$$

(here, W10/1000 is iron loss (W/kg) when the flux density of 1.0 T is induced at the frequency of 1,000 Hz, and t represents the thickness (mm) of the steel sheet.)

Equation 4 shows a numerical expression on a relationship between W10/1000 and steel sheet thickness (t). It is known that iron loss (W10/1000) decreases in proportion to the thickness, but the non-oriented electrical steel sheet has a unique steel composition and hardness characteristics, which means that the iron loss (W10/1000) is further reduced compared to a steel sheet of the same thickness. The lower limit of Equation 4 is not specifically restricted and is 0.

The hot rolled non-oriented electrical steel sheet removes scales by projecting shot balls onto the steel sheet during the manufacturing process, and improves iron loss after iron loss and stress removal annealing in the entire directions by controlling hardness of the surface and the inside.

A method for manufacturing a hot rolled non-oriented electrical steel sheet includes: manufacturing a hot rolled plate by hot rolling a slab including, in wt %, 2.8 to 4.0% of Si, 0.1 to 1.3% of Al, 0.3 to 2.0% of Mn, a balance Fe and inevitable impurities; and removing scales existing on the surface of the hot rolled plate.

Respective stages will now be described in detail.

A slab is hot rolled to manufacture a hot rolled plate. The steel composition of the slab has been described in the previously mentioned hot rolled non-oriented electrical steel sheet so the detailed description thereof will be omitted. The steel composition does not substantially change during the process for heating the slab, hot rolling the same, and annealing the hot rolled plate, which will be described later.

The slab may be heated before hot rolling the same. The temperature of heating the slab is not limited, but the slab may be heated at 1100 to 1250° C. When the slab heating temperature is very high, the deposition that damages magnetism may be re-dissolved and finely precipitated after hot rolling.

After hot rolling, the thickness of the hot rolled plate may be 2 to 3.0 mm.

After the manufacturing of a hot rolled plate, annealing the hot rolled plate may be further included. Hot rolled plate annealing is preferably performed when manufacturing high-grade electrical steel sheets without phase transformation, and it is effective in improving the texture of cold rolled annealed plates and enhancing the flux density.

At this time, the annealing of the hot rolled plate may be performed at the temperature of 850 to 1200° C. When the temperature of annealing the hot rolled plate is very low or below a predetermined value, the tissue does not grow or grows finely, making it difficult to expect the effect of increasing flux density. When the temperature of annealing the hot rolled plate becomes very high, the magnetic characteristics may be deteriorated, and the rolling workability may be deteriorated due to deformation of the plate shape. Hot rolled plate annealing is performed to increase the orientation favorable to magnetism as needed, and may be omitted. The annealed hot rolled plate may be pickled.

The scale existing on the surface of the hot rolled plate is removed. In an embodiment, the scale is removed using shot ball blasting, and a fine recrystallization fraction may be secured due to an increase in nucleation sites during recrystallization by controlling the projecting amount of shot balls.

The removing of scale includes projecting an appropriate amount of shot balls. The shot balls deposit energy on the surface of a material to increase the hardness of the surface. In this process, the scale is removed by projecting the shot balls onto the steel sheet in an amount that suppresses surface hardness, but the surface is not hardened. When the surface hardness is HV1 and the ½t hardness in the depth direction is HV2, Equation 1 is satisfied.

$$1.1 \leq Hv 1 / HV 2 \leq 1.5 \qquad [ Equation 1 ]$$

(here, HV1 is hardness measured on the surface of steel sheet, and HV2 is hardness measured at the ½ point of the thickness of the steel sheet.)

By controlling the ratio of hardness on the surface and the inside after projecting shot balls, the accumulated energy on the surface may be reduced when removing scales. By this, influences may be applied to recrystallization during a final annealing, and deviation of the high-frequency iron loss in the directions of 0, 45, and 90 degrees of angle with respect to the rolling direction may be reduced. In detail, the ratio of Hv1/Hv2 may be 1.2 to 1.4.

The hardness is Vickers hardness, and may be measured at a load of 10 g using a micro Vickers hardness tester. Hv1 may be 250 to 400 Hv, and Hv2 may be 150 to 300 Hv.

The amount of projecting shot balls may be 15 to 35 kg/(min·m²). The fine recrystallization fraction may be secured due to an increase in nucleation sites during recrystallization by controlling the amount of projecting shot balls. In detail, the amount of projecting shot balls may be 17 to 32 kg/(min·m²).

An average particle size of the shot balls is 0.1 to 1 mm, and they may be projected for 1 second to 60 seconds. In detail, the average particle size of the shot balls may be 0.3 to 0.8 mm, and they may be projected for 5 seconds to 30 seconds. The average particle size of shot balls and the time of projecting shot balls may give an influence to the surface nucleation site.

The material of shot balls is not specifically limited, and a Fe-based alloy may be used.

After the shot ball projection, the surface of the steel sheet may be made smooth by immersing the steel sheet in a pickling solution. The pickling solution is not particularly limited, and a hydrochloric acid may be used. When the concentration or the immersion time of the pickling solution is too low or short, the roughness of the steel sheet having an increased projection amount is increased, resulting in a problem on a surface. When the concentration or the immersion time of the pickling solution is too high or long, the surface of the steel sheet may be damaged much. More specifically, the pickling may be performed by immersion in the pickling solution for 10 to 60 seconds.

The method for manufacturing a non-oriented electrical steel sheet according to an embodiment includes: manufacturing a hot rolled plate by hot rolling the slab including 2.8 to 4.0% of Si, 0.1 to 1.3% of Al, 0.3 to 2.0% of Mn as wt %, a balance Fe, and inevitable impurities; removing scales from the surface of the hot rolled plate; manufacturing a cold-rolled steel sheet by cold rolling the scale-removed hot rolled plate; and annealing the cold-rolled steel sheet.

The manufacturing of a hot rolled plate and the removing of scales from the surface of the hot rolled plate have been described in the method for manufacturing a hot rolled non-oriented electrical steel sheet so repeated portions will not be described.

The cold-rolled steel sheet is manufactured by cold rolling the hot rolled plate. The cold rolling is final rolling with the thickness of 0.15 mm to 0.65 mm. If necessary, second cold rolling may be performed after the first cold rolling and intermediate annealing, and a final reduction rate may be in the range of 50 to 95%.

The cold-rolled steel sheet is annealed. Cold rolled sheet annealing is performed in the range of 700 to 850° C. for 10 to 1000 seconds so that the crystal grain size on the steel sheet cross section is 5 to 50 μm. When the cold rolled sheet annealing temperature is very low, crystal grains are small so that iron loss may be deteriorated. When the temperature is very high, the crystal grains are coarsened, and mechanical strength may be decreased. In detail, the annealing may be performed in the range of 740 to 820° C.

After the annealing of the cold rolled sheet, 80% by area or more of the texture worked by the cold rolling of the steel sheet may be recrystallized.

In an embodiment, influences may be applied to recrystallization during annealing a cold-rolled steel sheet, and deviation of the high-frequency iron loss in the directions of 0, 45, and 90 degrees of angle with respect to the rolling direction may be reduced. In detail, after the annealing of a cold-rolled steel sheet, the steel sheet may satisfy Equation 2 and Equation 3.

$$2 \vert WL - WC \vert / ( WL + WC ) \leq 0.1 \qquad [ Equation 2 ]$$

$$2 \vert WL + WC - 2 WN \vert / ( WL + WC ) \leq 0.1 \qquad [ Equation 3 ]$$

(in Equation 2 and Equation 3, WL is iron loss (W10/1000, W/kg) measured in the rolling direction, WC is iron loss (W10/1000, W/kg) measured in a vertical direction to the rolling direction, and WN is iron loss (W10/1000, W/kg) measured in the direction forming the angle of 45 degrees with respect to the rolling direction. W10/1000 is iron loss (W/kg) when the flux density of 1.0 T is induced at the frequency of 1,000 Hz.)

Equation 2 and Equation 3 may formulate the deviation of high-frequency iron loss in the directions of 0, 45, and 90 degree. The smaller the values of Equation 2 and Equation 3, the smaller the deviation of iron loss. When manufacturing a motor using the non-oriented electrical steel sheet satisfying these, the efficiency of the motor may be maximized. In detail, values of Equation 2 and Equation 3 may be 0.09 or less. The lower limits of Equation 2 and Equation 3 are not specifically restricted and are 0.

An insulating film may be formed after the annealing of a cold-rolled steel sheet. The insulating film may be treated with organic, inorganic, and organic and inorganic composite coating films, and may also be treated with other coating agents capable of insulation. For example, it may be formed by applying an insulating film forming composition including 40 to 70 wt % of a metal phosphate and 0.5 to 10 wt % of silica.

After the annealing of a cold-rolled steel sheet, performing punching, stacking, and stress removal annealing may be further included. In the stress removal annealing, magnetism may be further improved by removing the stress applied to the non-oriented electrical steel sheet at the time of performing punching and stacking. The stress removal annealing may be performed at the temperature of 700 to 850° C. for 10 to 300 minutes. In detail, it may be performed at the temperature of 750 to 800° C. for 30 to 180 minutes.

After the stress removal annealing, the steel sheet may satisfy Equation 4.

$$W 10 / 1000 \leq 20 + t \times 150 \qquad [ Equation 4 ]$$

(here, W10/1000 is iron loss (W/kg) when the flux density of 1.0 T is induced at the frequency of 1,000 Hz, and t is thickness (mm) of the steel sheet.)

Equation 4 shows a numerical expression on the relationship between W10/1000 and thickness (t) of the steel sheet. It is known that iron loss (W10/1000) decreases in proportion to the thickness, but the non-oriented electrical steel sheet has a unique steel composition and hardness characteristics, which means that the iron loss (W10/1000) is further reduced compared to a steel sheet of the same thickness. The lower limit of Equation 4 is not specifically restricted and is 0.

Embodiments and comparative examples will now be described. However, the following embodiments are preferable embodiments and the present disclosure is not limited to them.

### Embodiment 1

The slab configured with what are shown in Table 1, the balance of Fe, and other inevitable impurities is manufactured. The slab is heated at 1150° C., and is hot finish rolled at 850° C. to manufacture the hot rolled plate with the thickness of 2.3 mm. The hot rolled plate is annealed at 1100° C. for 4 minutes. The steel shot balls with the average diameter of 0.5 μm are blasted with the projecting amounts expressed in Table 2 to remove the scale and perform pickling. The thickness thereof is made as 0.27 mm through a cold rolling, and the cold-rolled steel sheet is annealed at 800° C. for 5 minutes.

The respective component contents are measured by an ICP wet analysis method. The iron loss characteristic is measured by a single sheet tester by incising specimens of 60 mm (width)×60 mm (length)×5 (sheets) for the respective specimens. After stress removal annealing, iron loss is measured, while annealing the specimens at 750° C. for 120 minutes.

The hardness of the specimen is measured with a load of 10 g using a micro Vickers hardness tester after blasting

TABLE 1

| Steel type | Si | Al | Mn | Cr | Sn | Sb |
|---|---|---|---|---|---|---|
| 1 | 2.8 | 0.28 | 0.7 | 0.113 | 0.005 | 0.045 |
| 2 | 3.0 | 0.73 | 1.4 | 0.041 | 0.006 | 0.042 |
| 3 | 3.2 | 0.30 | 0.6 | 0.161 | 0.017 | 0.011 |
| 4 | 3.4 | 0.17 | 0.5 | 0.048 | 0.049 | 0.032 |
| 5 | 3.6 | 0.35 | 1.8 | 0.164 | 0.005 | 0.017 |
| 6 | 3.8 | 1.00 | 2.0 | 0.048 | 0.045 | 0.042 |
| 7 | 4.0 | 1.04 | 0.9 | 0.136 | 0.005 | 0.021 |
| 8 | 2.7 | 1.11 | 1.0 | 0.184 | 0.035 | 0.007 |
| 9 | 4.1 | 0.96 | 1.1 | 0.074 | 0.049 | 0.019 |
| 10 | 3.9 | 0.07 | 1.6 | 0.155 | 0.012 | 0.031 |
| 11 | 4.0 | 1.33 | 1.8 | 0.033 | 0.038 | 0.041 |
| 12 | 3.1 | 0.55 | 0.2 | 0.113 | 0.011 | 0.015 |
| 13 | 3.9 | 0.18 | 2.1 | 0.076 | 0.006 | 0.032 |
| 14 | 3.3 | 0.30 | 1.7 | 0.005 | 0.008 | 0.028 |
| 15 | 3.1 | 0.24 | 0.6 | 0.210 | 0.025 | 0.023 |
| 16 | 2.8 | 0.79 | 0.6 | 0.119 | 0.003 | 0.047 |
| 17 | 3.3 | 0.34 | 1.1 | 0.083 | 0.065 | 0.047 |
| 18 | 3.3 | 0.48 | 0.4 | 0.062 | 0.017 | 0.003 |
| 19 | 3.6 | 0.43 | 0.9 | 0.180 | 0.013 | 0.065 |
| 20 | 2.8 | 0.63 | 1.3 | 0.189 | 0.038 | 0.019 |
| 21 | 3.5 | 0.67 | 1.8 | 0.146 | 0.050 | 0.050 |
| 22 | 3.0 | 0.52 | 1.5 | 0.058 | 0.039 | 0.040 |
| 23 | 3.3 | 0.65 | 1.5 | 0.137 | 0.029 | 0.035 |

TABLE 2

| | | Shot | | | |
|---|---|---|---|---|---|
| | Shot ball | ball | | | |
| | projecting | projecting | | | Hardness |
| Steel | amount | time | Hardness | Hardness | ratio |
| type | (kg/min · m²) | (sec.) | HV1 | HV2 | Hv1/HV2 |
| 1 | 29 | 15 | 253 | 188 | 1.35 |
| 2 | 24 | 30 | 274 | 223 | 1.23 |
| 3 | 35 | 30 | 310 | 210 | 1.48 |
| 4 | 28 | 30 | 288 | 217 | 1.32 |
| 5 | 20 | 30 | 301 | 259 | 1.16 |
| 6 | 25 | 30 | 360 | 288 | 1.25 |
| 7 | 30 | 30 | 380 | 279 | 1.36 |
| 8 | 15 | 15 | 221 | 204 | 1.08 |
| 9 | 33 | 45 | 415 | 287 | 1.44 |
| 10 | 16 | 45 | 296 | 267 | 1.11 |
| 11 | 17 | 60 | 336 | 303 | 1.11 |
| 12 | 22 | 30 | 240 | 201 | 1.20 |
| 13 | 15 | 45 | 305 | 280 | 1.09 |
| 14 | 19 | 30 | 273 | 238 | 1.15 |
| 15 | 33 | 30 | 294 | 203 | 1.45 |
| 16 | 31 | 30 | 272 | 196 | 1.39 |
| 17 | 18 | 30 | 257 | 227 | 1.13 |
| 18 | 30 | 30 | 295 | 216 | 1.37 |
| 19 | 16 | 45 | 268 | 243 | 1.10 |
| 20 | 10 | 30 | 214 | 207 | 1.04 |
| 21 | 40 | 45 | 430 | 259 | 1.66 |
| 22 | 13 | 30 | 221 | 214 | 1.03 |
| 23 | 37 | 30 | 315 | 205 | 1.54 |

TABLE 3

| Steel | | | | | | W10/1000 after |
|---|---|---|---|---|---|---|
| type | WL | WC | WN | Equation 2 | Equation 3 | SRA |
| 1 | 46.19 | 50.49 | 49.20 | 0.089 | 0.036 | 48.59 |
| 2 | 41.88 | 45.19 | 44.55 | 0.076 | 0.046 | 43.54 |
| 3 | 44.82 | 48.87 | 48.93 | 0.086 | 0.089 | 47.16 |
| 4 | 44.54 | 48.36 | 48.27 | 0.082 | 0.078 | 46.75 |
| 5 | 40.82 | 43.45 | 42.82 | 0.062 | 0.033 | 42.14 |
| 6 | 37.71 | 40.85 | 40.27 | 0.080 | 0.050 | 39.28 |
| 7 | 38.90 | 42.37 | 42.12 | 0.085 | 0.073 | 40.63 |
| 8 | 44.19 | 48.26 | 49.26 | 0.088 | 0.131 | 46.22 |
| 9 | 38.02 | 42.12 | 41.85 | 0.102 | 0.089 | 40.07 |
| 10 | 41.49 | 43.66 | 44.86 | 0.051 | 0.107 | 42.57 |
| 11 | 36.25 | 40.24 | 38.67 | 0.104 | 0.022 | 38.24 |
| 12 | 45.39 | 49.56 | 50.12 | 0.088 | 0.111 | 47.48 |
| 13 | 39.15 | 43.54 | 41.73 | 0.106 | 0.018 | 41.35 |
| 14 | 42.26 | 46.34 | 44.19 | 0.092 | 0.005 | 43.55 |
| 15 | 46.02 | 50.39 | 50.38 | 0.091 | 0.090 | 48.21 |
| 16 | 44.10 | 48.49 | 48.10 | 0.095 | 0.078 | 46.29 |
| 17 | 43.51 | 46.91 | 47.35 | 0.075 | 0.095 | 44.76 |
| 18 | 43.70 | 48.25 | 48.21 | 0.099 | 0.097 | 45.97 |
| 19 | 42.57 | 44.77 | 45.80 | 0.050 | 0.097 | 43.67 |
| 20 | 44.15 | 45.81 | 48.25 | 0.037 | 0.145 | 44.98 |
| 21 | 38.02 | 44.67 | 44.06 | 0.161 | 0.132 | 41.34 |
| 22 | 42.63 | 47.01 | 46.33 | 0.098 | 0.068 | 44.86 |
| 23 | 44.15 | 48.72 | 47.54 | 0.098 | 0.047 | 45.47 |

As expressed in Table 1 to Table 3, it is confirmed that Steel types 1 to 7, and 14 to 19 having adjusted the alloy components and the hardness after shot blasting increase iron loss and anisotropy of iron loss.

It is confirmed that Steel types 8 to 13 failing to satisfy the alloy components deteriorate iron loss and anisotropy of iron loss. It is confirmed that Steel types 8, and 20 to 23 not satisfying the hardness ratio of the hot rolled plate deteriorate iron loss and anisotropy of iron loss.

Steel types 14 to 19 are confirmed that they do not include an appropriate amount of Cr, Sn, or Sb, and their magnetism is partly deteriorated.

The present disclosure is not limited to the embodiments and may be produced in various forms, and it will be understood by those skilled in the art to which the present disclosure pertains that embodiments of the present disclosure may be implemented in other specific forms without modifying the technical spirit or essential features of the present disclosure. Therefore, it should be understood that the aforementioned embodiments are illustrative in terms of all aspects and are not limited.

1. A hot rolled non-oriented electrical steel sheet comprising:
2.8 to 4.0% of Si, 0.1 to 1.3% of Al, 0.3 to 2.0% of Mn as wt %, a balance of Fe, and inevitable impurities, and satisfying Equation 1:
$$1.1 \leq Hv 1 / HV 2 \leq 1.5 \qquad [ Equation 1 ]$$
(here, Hv1 is hardness measured on a surface of the steel sheet, and Hv2 is hardness measured at a ½ point of thickness of the steel sheet.)

2. The hot rolled non-oriented electrical steel sheet of claim 1, further comprising
at least one of 0.2 wt % or less of Cr (excluding 0%), 0.06 wt % or less of Sn (excluding 0%), and 0.06 wt % or less of Sb (excluding 0%).

3. The hot rolled non-oriented electrical steel sheet of claim 1, further comprising
at least one of 0.01 to 0.2 wt % of Cu, 0.100 wt % or less of P (excluding 0%), 0.05 wt % or less of Ni (excluding 0%), and 0.01 wt % or less of Zn (excluding 0%).

4. The hot rolled non-oriented electrical steel sheet of claim 1, further comprising
0.005 wt % or less of one or more of C, N, S, Ti, Nb, and V individually or as a summed content thereof (excluding 0%).

5. The non-oriented electrical steel sheet of claim 1, further comprising
0.200 wt % or less of one or more of Bi, Pb, Ge and As individually or as a summed content thereof (excluding 0%).

6. The non-oriented electrical steel sheet of claim 1, further comprising
at least one of 0.03 wt % or less of Mo (excluding 0%), 0.0050 wt % or less of B (excluding 0%), 0.0050 wt % or less of Ca (excluding 0%), and 0.0050 wt % or less of Mg (excluding 0%).

7. A non-oriented electrical steel sheet comprising:
2.8 to 4.0% of Si, 0.1 to 1.3% of Al, 0.3 to 2.0% of Mn as wt %, a balance of Fe, and inevitable impurities, and satisfying Equation 2 and Equation 3:
$$2 \vert WL - WC \vert / ( WL + WC ) \leq 0.1 \qquad [ Equation 2 ]$$
$$2 \vert WL + WC - 2 WN \vert / ( WL + WC ) \leq 0.1 \qquad [ Equation 3 ]$$
(in Equation 2 and Equation 3, WL is iron loss (W10/1000, W/kg) measured in a rolling direction, WC is iron loss (W10/1000, W/kg) measured in a vertical direction to the rolling direction, and WN is iron loss (W10/1000, W/kg) measured in the direction forming the angle of 45 degrees with respect to the rolling direction. W10/1000 is iron loss (W/kg) when flux density of 1.0 T is induced at a frequency of 1000 Hz.)

8. The non-oriented electrical steel sheet of claim 7, wherein
an average grain particle diameter is 5 to 50 μm.

9. The non-oriented electrical steel sheet of claim 7, wherein
Equation 4 is satisfied after stress removal annealing:
$$W 10 / 1000 \leq 20 + t \times 150 \qquad [ Equation 4 ]$$
(here, W10/1000 is iron loss (W/kg) when the flux density of 1.0 T is induced at the frequency of 1000 Hz, and t is thickness (mm) of the steel sheet)

10. A method for manufacturing a hot rolled non-oriented electrical steel sheet comprising:
manufacturing a hot rolled plate by hot rolling a slab including 2.8 to 4.0% of Si, 0.1 to 1.3% of Al, 0.3 to 2.0% of Mn as wt %, a balance of Fe, and inevitable impurities; and
removing a scale existing on a surface of the hot rolled plate,
wherein the removing of a scale includes removing a scale by projecting a shot ball on to a steel sheet, and
Equation 1 is satisfied after projecting a shot ball:
$$1.1 \leq Hv 1 / HV 2 \leq 1.5 \qquad [ Equation 1 ]$$
(here, Hv1 is hardness measured on the surface of steel sheet, and Hv2 is hardness measured at the ½ of the thickness of the steel sheet.)

11. The method of claim 10, wherein
a projecting amount of the shot balls is 15 to 35 kg/(min·m²).

12. The method of claim 10, wherein
an average particle size of the shot ball is 0.1 to 1 mm, and is projected for 1 second to 60 seconds.

13. The method of claim 10, wherein
the shot ball is made of a Fe-based alloy.

14. The method of claim 10, further comprising
annealing a hot rolled plate before the removing of a scale.

15-17. (canceled)
